(19) United States
(12) Patent Application Publication
(10) Pub. No.: US 2011/0119975 A1
(43) Pub. Date: May 26, 2011

(54) MARKING PANEL LED LIGHT EMITTING MODULE

(75) Inventor: Ping-Yu KUO, Taichung City (TW)

(73) Assignee: SAFETY TRAFFIC EQUIPMENT Co., Ltd., Taichung City (TW)

(21) Appl. No.: 12/626,332

(22) Filed: Nov. 25, 2009

(51) Int. Cl. G09F 13/00; F21S 4/00

(52) U.S. Cl. 40/578; 362/249.02

(57) ABSTRACT

A combined LED light-emitting module of marking panel has a rail-mounted rack, extended longitudinally containing a locating portion for positioning onto the marking panel, and an assembly portion. A plurality of LED light-emitting units are mounted onto the assembly portion in sequence or at interval. The LED light-emitting unit contains a support pedestal, a light-emitting faceplate, a circuit board and at least a light-emitting component on the circuit board. The light-emitting faceplate is sealed into the holding space of the support pedestal. The circuit board is mounted into the holding space and the light-emitting component is allowed to face the light-emitting faceplate. The circuit board is sealed by waterproof element. A limiter is used to limit securely the LED light-emitting units. A quick-release electrical connector, protruded from the back board of the support pedestal contains male and female conductive contacts that can be quickly removed and assembled.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to a LED light-emitting mechanism of marking panel, and more particularly to an innovative one which enables more convenient and efficient assembly, disassembly and replacement of LED light-emitting units and electrical connectors.

2. Description of Related Art Including Information Disclosed Under 37 CFR 1.97 and 37 CFR 1.98

The currently available traffic marking panels and other indicating or labeling panels (marking panel) are generally combined with LED components for highlighting their letters and patterns in an energy-saving and cost-efficient way.

The LED components on the surface of conventional marking panel are generally arranged in such a manner that LED components along with the circuit board are firstly fabricated into a platy light-emitting unit, and then adhered securely onto the letters and patterns of the marking panel. Yet, it is observed during actual applications that, since LED light-emitting units are fixed onto the surface of conventional marking panel, when replacement is required in the event of any damage, this will lead possibly to peeling-off of the letters and patterns if removing the defective light-emitting units. The disassembly and repair convenience of connecting lines for various light-emitting units has to be considered.

Thus, to overcome the aforementioned problems of the prior art, it would be an advancement if the art to provide an improved structure that can significantly improve the efficacy.

Therefore, the inventor has provided the present invention of practicability after deliberate experimentation and evaluation based on years of experience in the production and development of related products.

### BRIEF SUMMARY OF THE INVENTION

The enhanced efficacy of the present invention is as follows:

Based on the unique configuration of the present invention that the combined LED light-emitting module mainly comprises rail-mounted rack, LED light-emitting units, limiter and quick-release electrical connector, the LED light-emitting unit of the marking panel and the electrical connector can be easily assembled, disassembled and replaced with improved applicability and industrial benefits.

The improvements brought about by this invention are as follows:

Based on the structural configuration of the railed assembly portion of the rail-mounted rack, the LED light-emitting units can slide along the rail, so that the LED light-emitting units can be arranged with an adjustable spacing, thus eliminating the limit of quantities of LED light-emitting units, and enabling more flexible assembly of the LED light-emitting components of the marking panel to meet the diversified requirements.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 shows a perspective view of the preferred embodiment of the present invention (partially exploded).

FIG. 2 shows a front view of the preferred embodiment of the present invention.

FIG. 3 shows a perspective view of the present invention that a quick-release electrical connector is set at the back of the LED light-emitting unit.

FIG. 4 shows a cross-sectional view of the assembled preferred embodiment of the present invention.

FIG. 5 shows a top view of the present invention that the width of the guiding seat is the same as the LED light-emitting unit.

FIG. 6 shows a top view of the present invention that the width of the guiding seat is less than the LED light-emitting unit.

FIG. 7 shows an exploded perspective view of the LED light-emitting unit of the present invention.

FIG. 8 shows a schematic view of the present invention where the light-emitting component is exposed onto the light-emitting faceplate.

FIG. 9 shows a schematic view of the present invention where the light-emitting component is embedded into the light-emitting faceplate.

FIG. 10 shows another schematic view of the present invention where the LED light-emitting unit and rail-mounted rack are assembled together.

FIG. 11 shows the other schematic view of the present invention where the LED light-emitting unit and rail-mounted rack are assembled together.

FIG. 12 shows a schematic view of the present invention where the combined LED light-emitting module is applied to traffic indicator panel.

FIG. 13 shows a perspective view of the present invention that the limiter is also assembled with an auxiliary baffle plate.

FIG. 14 shows an exploded perspective view of another preferred embodiment of the present invention where the LED light-emitting unit and rail-mounted rack are assembled together.

FIG. 15 shows a perspective view of another preferred embodiment of the present invention where the LED light-emitting unit and rail-mounted rack are assembled together.

### DETAILED DESCRIPTION OF THE INVENTION

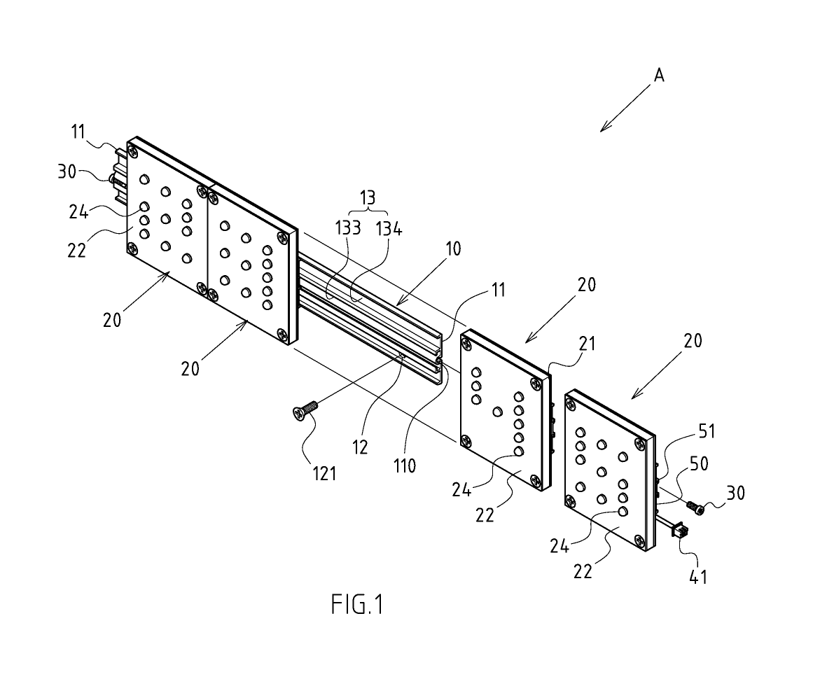

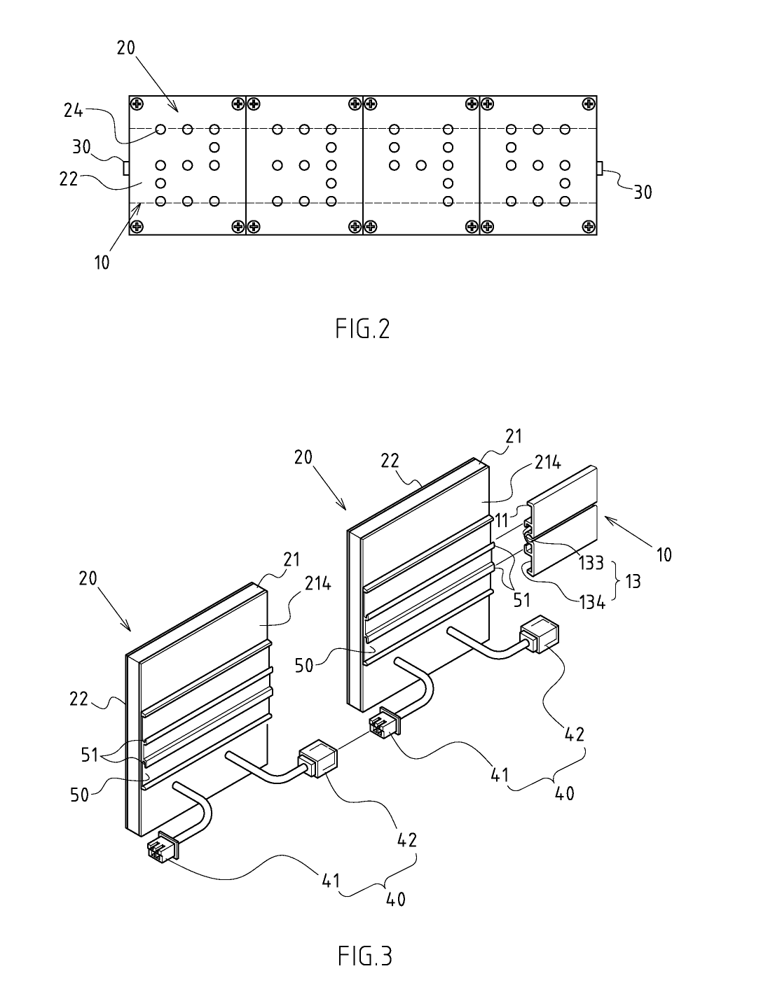

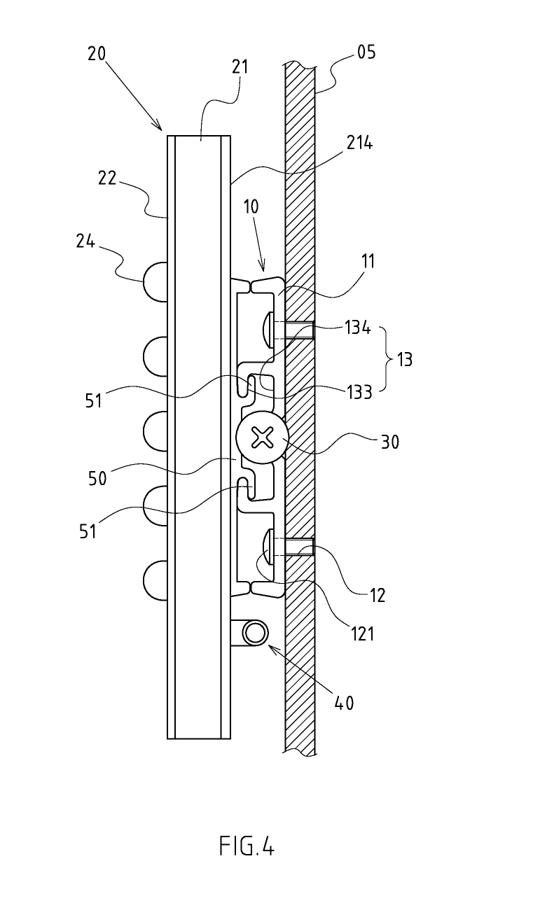

FIGS. 1-4 depict preferred embodiments of a combined LED light-emitting module of marking panel of the present invention, which, however, are provided for only explanatory objective for patent claims. At least one combined LED light-emitting module A is assembled securely on the surface of a marking panel 05 (shown in FIG. 4) for the purpose of luminous marking and indication.

This combined LED light-emitting module A includes a rail-mounted rack 10, extended to define two extensions 11. The rail-mounted rack 10 includes of a locating portion 12 for positioning onto the marking panel 05 and an assembly portion 13 extended along the rail-mounted rack 10.

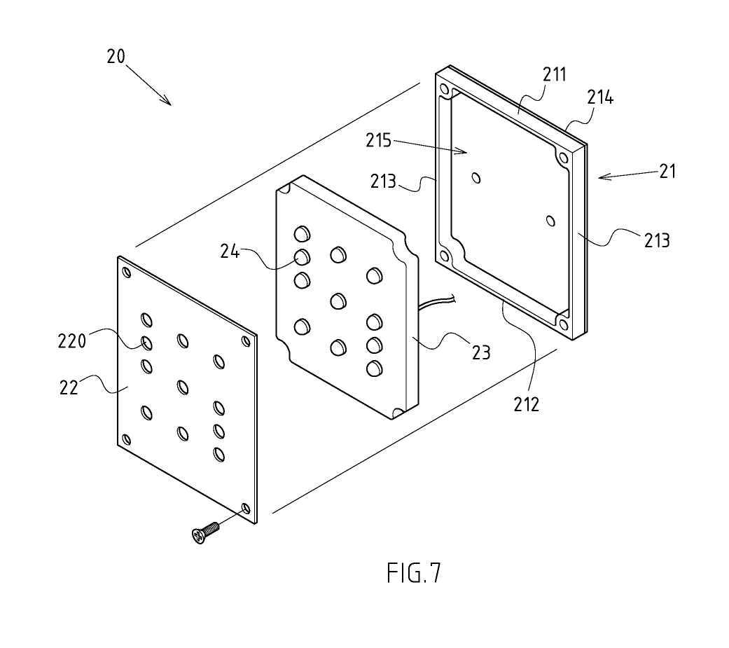

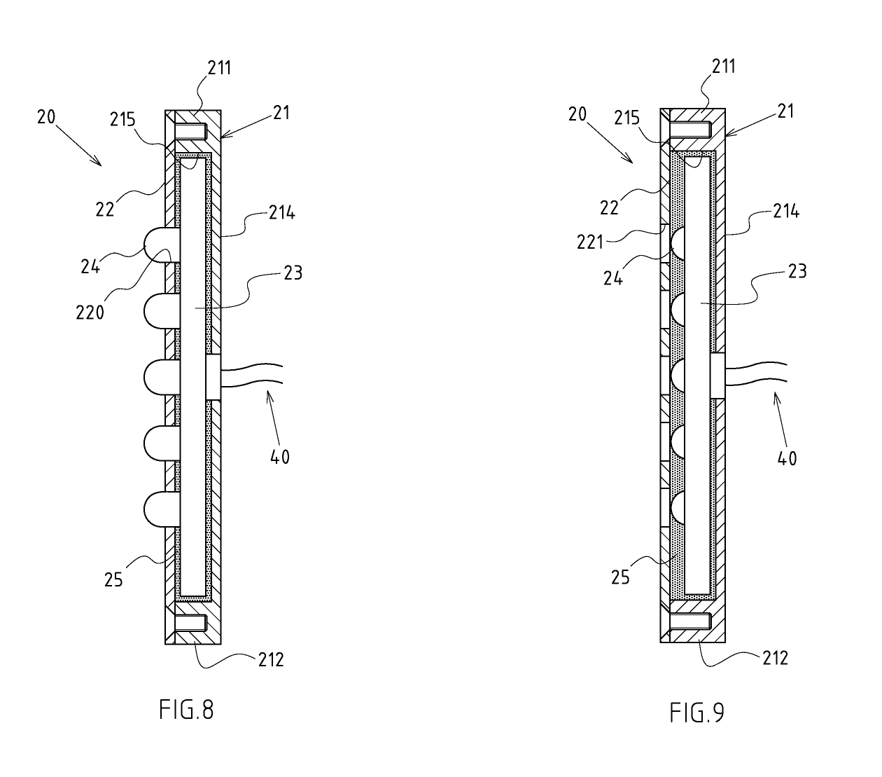

A plurality of LED light-emitting units 20 are mounted onto the assembly portion 13 of the rail-mounted rack 10 in sequence or at interval. The LED light-emitting unit 20 contains a support pedestal 21, a light-emitting faceplate 22, a circuit board 23 and at least one light-emitting component 24 on the circuit board 23. Referring to FIG. 7, the detailed structure of the support pedestal 21 includes a top side 211, a bottom side 212, two side edges 213, a back board 214 and a holding space 215. The light-emitting faceplate 22 is sealed into the holding space 215 of the support pedestal 21. The circuit board 23 is mounted into the holding space 215, and the light-emitting components 24 are allowed to face the light-emitting faceplate 22. The circuit board 23 is sealed by waterproof element 25 (shown in FIGS. 8, 9), so as to protect the circuit board 23 against external moisture.

A limiter 30, used to limit securely the LED light-emitting units 20, is assembled onto the assembly portion 13.

A quick-release electrical connector 40, referring to FIG. 3, is protruded from the back board 214 of the support pedestal 21 of the LED light-emitting units 20. The quick-release electrical connector 40 contains male and female conductive contacts 41, 42 that can be quickly removed and assembled.

As for the rail-mounted rack 10 disclosed in FIGS. 1-4, the assembly portion 13 includes a rail 134 with snapping flange 133, so that a guiding seat 50 with mating flange 51 can be mounted externally onto the back board 214 of the support pedestal 21 of the LED light-emitting unit 20. The mating flange 51 can be interlocked with the snapping flange 133 of the rail 134 in a slidable state.

The locating portion 12 of the rail-mounted rack 10 includes a plurality of through-holes, so that the bolt 121 can be fastened onto the marking panel 05 (shown in FIGS. 1 and 4).

Referring to FIGS. 1 and 4, the limiter 30 includes a bolt locked onto the extension 11 of the rail-mounted rack 10, so that the extension 11 of the rail-mounted rack 10 is provided with screw hole 110 for screwing of the bolt (i.e. limiter 30). With this configuration, the LED light-emitting unit 20 can be blocked off by the limiter 30 without disengagement.

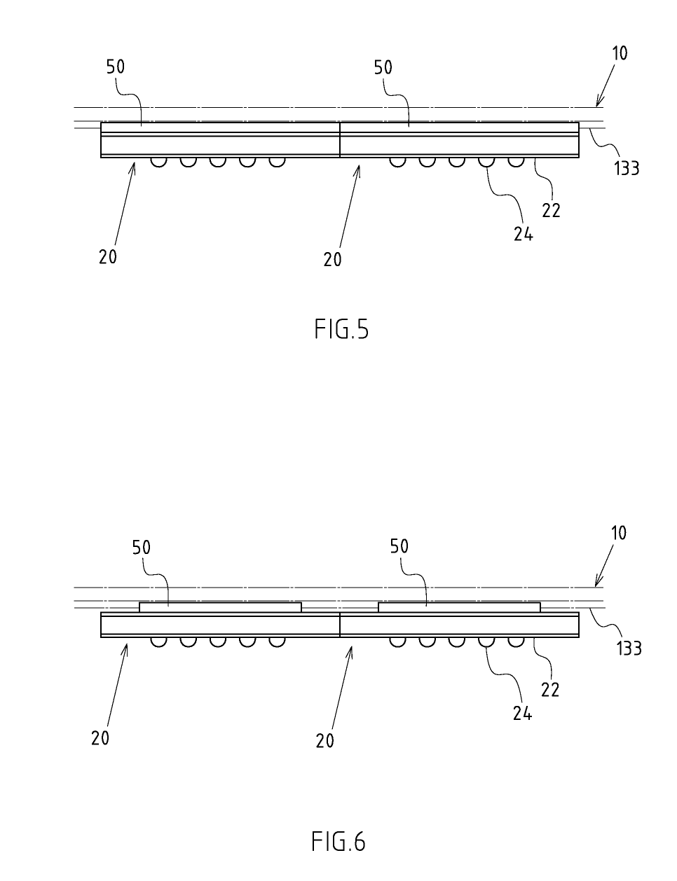

Referring to FIG. 5, the width of the guiding seats 50 is the same as LED light-emitting units 20, so the guiding seats 50 can be abutted together when the LED light-emitting units 20 are arranged alongside. Alternatively, referring to FIG. 6, the width of the retracted guiding seat 50 is less than LED light-emitting units 20, so the guiding seats 50 are located at interval when the LED light-emitting units 20 are arranged alongside.

Referring to FIGS. 7 and 8, the light-emitting faceplate 22 of LED light-emitting unit 20 is provided with through-holes 220, allowing the light-emitting components 24 on the circuit board 23 to protrude from the light-emitting faceplate 22.

Referring also to FIG. 9, the light-emitting faceplate 22 of LED light-emitting unit 20 is provided with light-transmitting portions 221. The light-emitting components 24 on the circuit board 23 are buried into the light-emitting faceplate 22, so that the rays from the light-emitting components 24 can be transmitted through the light-transmitting portion 221 of the light-emitting faceplate 22.

The waterproof element 25 covering the circuit board 23 of the LED light-emitting unit 20 (shown in FIGS. 8, 9) is made of waterproof glue.

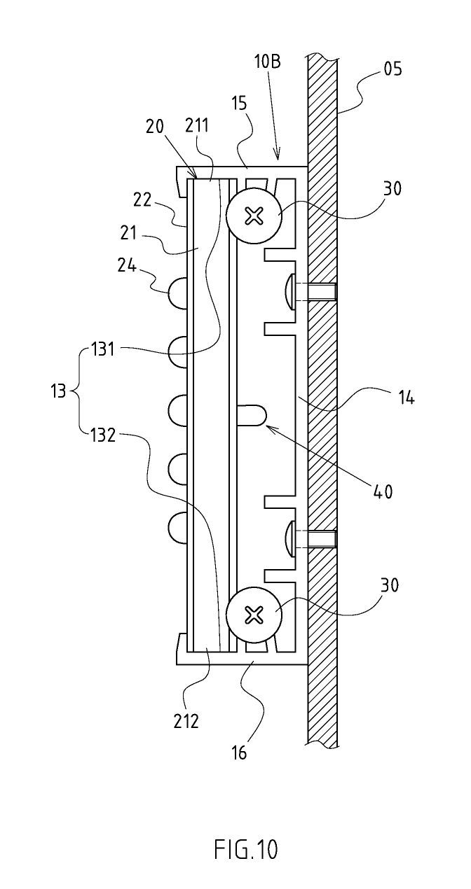

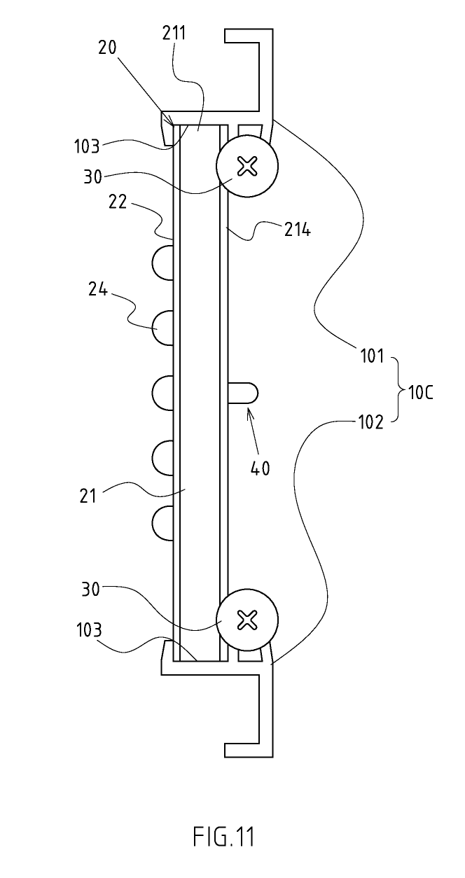

Referring to FIG. 10, the rail-mounted rack 10B is also a U-shaped extruded rack that defines a dorsal edge 14, a top side 15 and bottom side 16. The assembly portion 13 includes a top guiding groove 131 and a bottom guiding groove 132 formed correspondingly by the top and bottom sides 15, 16. The top and bottom sides 211 and 212 of the support pedestal 21 of the LED light-emitting units 20 can be separately embedded into the top and bottom guiding grooves 131 and 132, such that the LED light-emitting units 20 can slidably shift along the top and bottom guiding grooves 131 and 132.

Referring also to FIG. 11, the rail-mounted rack 10C includes a top rack 101 and a bottom rack 102 arranged in parallel. A guideway 103 is arranged correspondingly to the top and bottom racks 101 and 102, such that the top and bottom sides 211 and 212 of the support pedestal 21 of the LED light-emitting units 20 can be separately embedded into the guideway 103 for the top and bottom racks 101 and 102, and the LED light-emitting units 20 can slidably shift along the guideway 103.

Based upon above-specified structural configuration, the key configuration of the combined LED light-emitting module A lies in that, the extended rail-mounted rack 10 is provided with assembly portion 13, allowing a plurality of LED light-emitting units 20 to be abutted in sequence or assembled at interval. Then, with the technical characteristic of the limiter 30, the defective LED light-emitting units 20 can be quickly removed and replaced without affecting other operational LED light-emitting units 20 or the marking panel 05. As the quick-release electrical connector 40 is composed of male and female conductive contacts 41 and 42, the circuits of LED light-emitting units 20 can be easily and quickly removed and assembled.

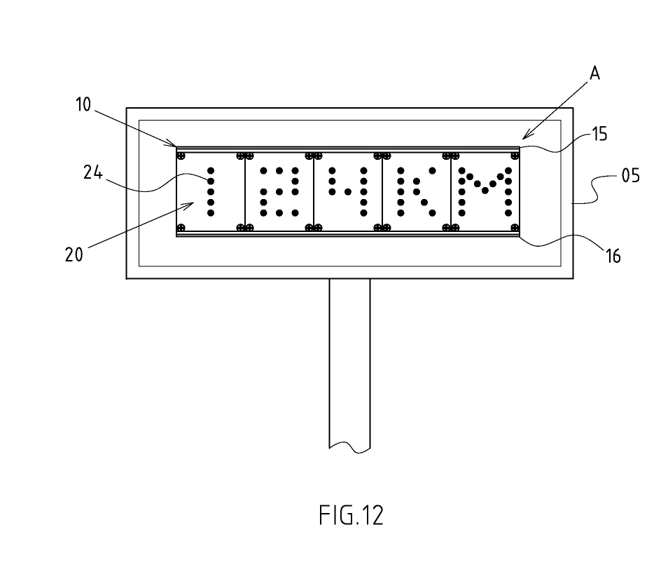

The application model of the combined LED light-emitting module A is shown in FIG. 12, wherein the marking panel 05 is a traffic indicator panel used to indicate the landmark, mileage or speed limit or places along the expressway. The combined LED light-emitting module A can be used for luminous indication.

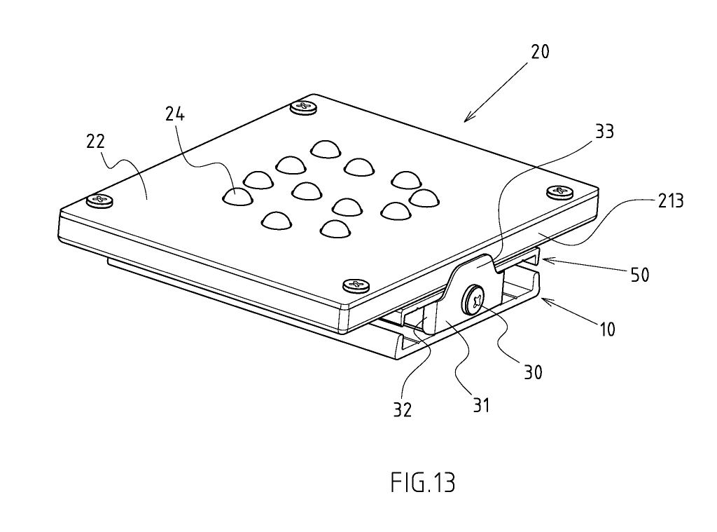

Referring also to FIG. 13, the limiter 30 is fitted additionally with an auxiliary baffle plate 31 for retaining and limitation purpose. An internal flange 32 is set onto at least one side of the auxiliary baffle plate 31 and embedded into the space formed by the rail-mounted rack 10 and guiding seat 50, so at to prevent the rotation of the auxiliary baffle plate 31. Moreover, a stopper of LED light-emitting unit 33 is extended from one side of the auxiliary baffle plate 31, and abutted onto a side edge 213 of the LED light-emitting unit 20 for more secure limitation effect.

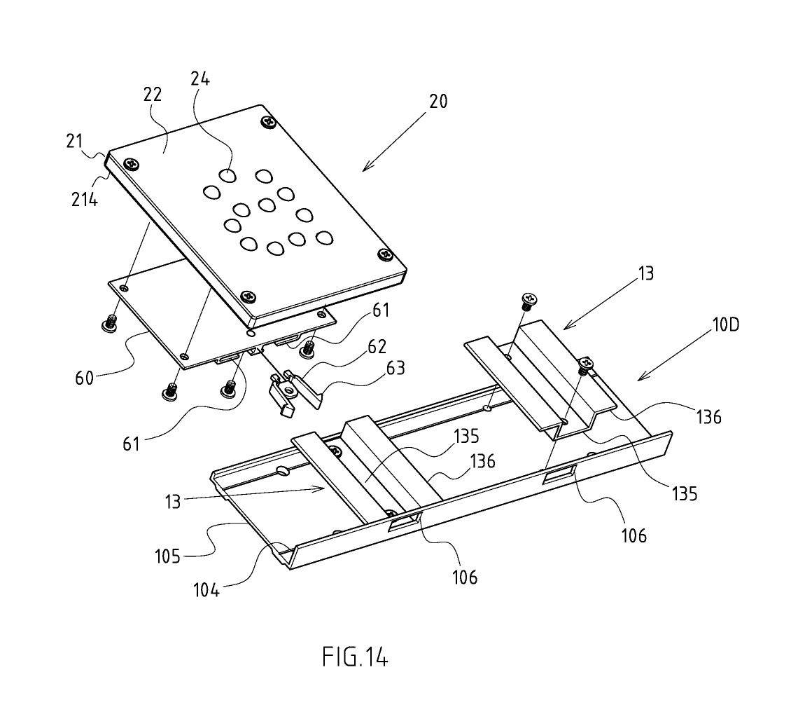

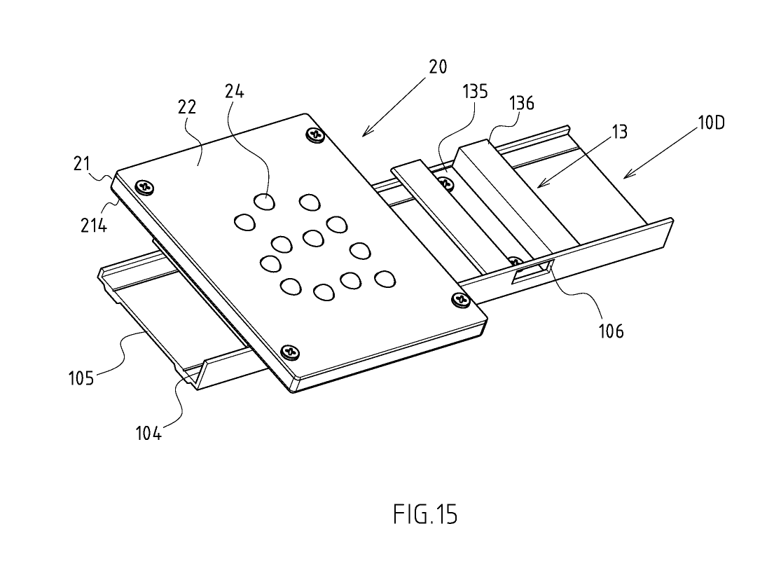

Referring also to FIGS. 14 and 15, the rail-mounted rack 10D comprises a transverse rack 105 with a bottom stopping flange 104. The assembly portion 13 of the rail-mounted rack 10D is composed of a plurality of vertical guiding seats 135 arranged at interval on the transverse rack 105. Moreover, the vertical guiding seat 135 is provided with embedded guiding flange 136. A guiding plate 60 with embedded sliding flange 61 is set externally onto the back board 214 of the support pedestal 21 of the LED light-emitting unit 20. The embedded sliding flange 61 can be mated with the embedded guiding flange 136 of the vertical guiding seat 135 in a slidable state. With this configuration, the guiding plate 60 along with the LED light-emitting unit 20 can slide along the vertical guiding seat 135, and can also be limited by the bottom stopping flange 104. Furthermore, the bottom stopping flange 104 of the transverse rack 105 is set with a locking slot 106 corresponding to the vertical guiding seat 135, whilst the guiding plate 60 is set with a flexible snapper seat 62, of which the flexible snapper seat 62 is provided with a flexible locating claw 63, so that the guiding plate 60 can be locked securely into the locking slot 106 when it is abutted with the bottom stopping flange 104. In the preferred embodiment, the LED light-emitting units 20 can be assembled or disassembled vertically, namely, any defective LED light-emitting unit 20 can be replaced quickly without affecting the others, thus meeting the requirements for multi-letter configuration.

1. A combined LED light-emitting module of marking panel, of which at least a combined LED light-emitting module is assembled securely on the surface of a marking panel for the purpose of luminous marking and indication; this combined LED light-emitting module comprising:
a rail-mounted rack, extended to define two extensions; the rail-mounted rack includes a locating portion for positioning onto the marking panel and an assembly portion;
a plurality of LED light-emitting units, mounted onto the assembly portion of the rail-mounted rack in sequence or at interval; the LED light-emitting unit includes a support pedestal, a light-emitting faceplate, a circuit board and at least a light-emitting component on the circuit board; the support pedestal includes a top side, a bottom side, two side edges, a back board and a holding space; the light-emitting faceplate is sealed into the holding space of the support pedestal; the circuit board is mounted into the holding space, and the light-emitting components are allowed to face the light-emitting faceplate; the circuit board is sealed by waterproof element;
a limiter, used to limit securely the LED light-emitting unit assembled onto the assembly portion; and
a quick-release electrical connector, protruded from the back board of the support pedestal of the LED light-emitting unit; the quick-release electrical connector contains male and female conductive contacts that can be quickly removed and assembled.

2. The structure defined in claim 1, wherein the rail-mounted rack is a U-shaped extruded rack that defines a dorsal edge, a top and bottom side; so the assembly portion includes a top guiding groove and a bottom guiding groove formed correspondingly by the top and bottom sides; the top and bottom sides of the support pedestal of the LED light-emitting unit can be separately embedded into the top and bottom guiding grooves, such that the LED light-emitting unit can slidably shift along the top and bottom guiding grooves.

3. The structure defined in claim 1, wherein the assembly portion of the rail-mounted rack includes a rail with snapping flange, so that a guiding seat with mating flange can be mounted externally onto the back board of the support pedestal of the LED light-emitting unit; the mating flange can be interlocked with the snapping flange of the rail in a slidable state.

4. The structure defined in claim 1, wherein the rail-mounted rack includes a top rack and a bottom rack arranged in parallel; a guideway is arranged correspondingly to the top and bottom racks, such that the top and bottom sides of the support pedestal of the LED light-emitting units can be separately embedded into the guideway for the top and bottom racks, and the LED light-emitting units can slidably shift along the guideway of the top and bottom racks.

5. The structure defined in claim 1, wherein the locating portion of the rail-mounted rack includes a plurality of through-holes.

6. The structure defined in claim 1, wherein the limiter includes a bolt locked onto the extension of the rail-mounted rack, so that the extension of the rail-mounted rack is provided with screw hole for screwing of the bolt.

7. The structure defined in claim 6, wherein the limiter is fitted additionally with an auxiliary baffle plate for retaining and limitation purpose.

8. The structure defined in claim 7, wherein an internal flange is set onto at least one side of the auxiliary baffle plate.

9. The structure defined in claim 7, wherein a stopper of LED light-emitting unit is extended from one side of the auxiliary baffle plate.

10. The structure defined in claim 1, wherein the light-emitting faceplate of LED light-emitting unit is provided with through-holes, allowing the light-emitting components on the circuit board to protrude from the light-emitting faceplate.

11. The structure defined in claim 1, wherein the light-emitting faceplate of LED light-emitting unit is provided with light-transmitting portions; the light-emitting components on the circuit board are buried into the light-emitting faceplate, so that the rays from the light-emitting components can be transmitted through the light-transmitting portion of the light-emitting faceplate.

12. The structure defined in claim 1, wherein the waterproof element covering the circuit board of the LED light-emitting unit is made of waterproof glue.

13. The structure defined in claim 1, wherein the rail-mounted rack includes a transverse rack with a bottom stopping flange; the assembly portion of the rail-mounted rack includes a plurality of vertical guiding seats arranged at interval on the transverse rack; moreover, the vertical guiding seat is provided with embedded guiding flange; a guiding plate with embedded sliding flange is set externally onto the back board of the support pedestal of the LED light-emitting unit; the embedded sliding flange can be mated with the embedded guiding flange of the vertical guiding seat in a slidable state; with this design, the guiding plate along with the LED light-emitting unit can slide along the vertical guiding seat, and can also be limited by the bottom stopping flange.

14. The structure defined in claim 13, wherein the bottom stopping flange of the transverse rack is set with a locking slot corresponding to the vertical guiding seat, whilst the guiding plate is set with a flexible snapper seat, of which the flexible snapper seat is provided with a flexible locating claw, so that the guiding plate can be locked securely into the locking slot when it is abutted with the bottom stopping flange.
